(19) United States
(12) Patent Application Publication
(10) Pub. No.: US 2007/0220917 A1
(43) Pub. Date: Sep. 27, 2007

(54) Process and Device for Evaporating an Oxygen-Enriched Working Fluid

(75) Inventor: Thomas Nohlen, Germering (DE)

Correspondence Address: CAHN & SAMUELS LLP, 2000 P STREET NW, SUITE 200, WASHINGTON, DC, 20036, US

(73) Assignee: LINDE AKTIENGESELLSCHAFT, Wiesbaden (DE)

(21) Appl. No.: 11/688,269

(22) Filed: Mar. 20, 2007

(30) Foreign Application Priority Data
Mar. 23, 2006 (DE) 06006032.4

(51) Int. Cl. F25J 3/00; F17C 13/00

(52) U.S. Cl. 62/643; 62/50.7

(57) ABSTRACT

A process and device for evaporating an oxygen-enriched working fluid by indirect heat exchange include introducing an oxygen-rich working fluid into the evaporation passages of an evaporator where it is partially evaporated. A first oxygen-enriched gas and a portion of the oxygen-enriched working fluid that remains liquid are drawn off from the evaporation passages. At least a part of the portion that remains liquid is returned to the evaporation passages as a circulation liquid by a conveying device. The conveying device for the circulation liquid injects a lift gas.

This application claims priority of European patent application EP 06006032.4, filed on Mar. 23, 2006, the disclosure of which is incorporated by reference in its entirety.

### BACKGROUND AND SUMMARY OF INVENTION

The invention relates to a process and device for evaporation of an oxygen-enriched working fluid by indirect heat exchange in an evaporator.

Such processes are used in, for example, low-temperature air separation units and serve to produce a gaseous oxygen product and/or to produce rising steam for a separation column. Forced circulation (liquid cycle) moves liquid in a circuit through evaporation passages and thus ensures an adequate liquid excess to prevent the evaporation passages from drying out. For example, forced circulation can be used in cascade evaporators as described in DE 1949609 C, WO 0192798 A2 (US 20050028554 A1 and U.S. Pat. No. 7,152,432 B2), EP 1287302 B1 (U.S. Pat. No. 6,748,763 B2) or WO 03012352 A2. More frequently, forced circulation is used in falling-film evaporators, whose use in low-temperature air separation units is known from EP 681153 B1, EP 795349 B1 (U.S. Pat. No. 5,901,574), EP 1094286 B1 (U.S. Pat. No. 6,430,961 B1), EP 1213552 A1, EP 1243882 B1 (U.S. Pat. No. 6,530,242 B2), DE 10115258 A1, EP 1308680 A1 (U.S. Pat. No. 6,612,129 B2), DE 20205751 U1, EP 1336805 A1 (US 20040055331 A1), DE 10213211 A1, DE 10213212 A1, DE 10232430 A1, DE 10302389 A1, EP 1482266 A1, DE 10334559 A1 and DE 10332863 A1.

The conveying device for the forced circulation (liquid cycle) is regularly formed by a low-temperature pump. In general, the pump is designed as a pair of pumps for purposes of redundancy.

The “upper level” of the liquid cycle refers here to the highest level in which the liquid in the liquid cycle is conveyed. It is at least somewhat higher than the upper end of the evaporation passages of the evaporator.

The “lower level” of the liquid cycle refers here to the lowest level in which the liquid in the liquid cycle is conveyed. It is lower than the lower end of the evaporation passages of the evaporator.

The object of the invention is to implement a process of the initially mentioned type with relatively low cost in terms of equipment and/or automatic control technology.

This object is achieved in that the conveying device for the circulation liquid comprises means for injecting a lift gas. In embodiments, the conveying device may comprise an air-lift pump (gas lift pump). The lift gas that is introduced reduces the density of the liquid stream so that the existing hydrostatic pressure is sufficient to transport the circulation liquid to the evaporation passages. As a result, mechanical pumps can be avoided for the operation of the evaporator or at least can be replaced by significantly smaller devices.

The replacement of mechanical pump output by the injection of lift gas had not previously been considered, since the production of a suitable lift gas requires more energy than a corresponding mechanical pump consumes. Within the scope of the invention, however, it has turned out that the simplification of equipment and the operational advantages of the air-lift pump outweigh this drawback. In particular, there is no question of redundancy. Also, the amount of circulation liquid can be set within a very wide range, without the equipment having to be altered. If, for example, the amount of circulation has to be increased during the operation of the unit, this can be achieved by a simple increase of the amount of lift gas. The process is especially simple to regulate by an air-lift pump and requires a relatively low cost in terms of automatic control technology.

According to the present invention, the height differences between the lower end of the evaporation passages and the lower level are greater than the height differences between the upper level and the upper end of the evaporation passages. The portion that remains liquid is thus conveyed first in the liquid cycle in a downward line from the lower end of the evaporation passages relatively far downward to the “lower level”. Then, the portion that remains liquid is raised in a riser, but only relatively slightly beyond the level of the upper end of the evaporation passages to the “upper level.” The relatively long downward line produces a higher hydrostatic head than in the riser, in which lift gas added from the outside reduces the density (specific weight) of the fluid due to gas bubbles in addition to liquid. This difference in hydrostatic head is the driving force for the liquid circulation. In the present invention, there is no evaporation in the liquid cycle of the portion that remains liquid. The only source of gas bubbles is from the externally injected lift gas.

Basically, each process stream that is available in gaseous form under corresponding pressure can be used as a lift gas. If the oxygen-enriched working fluid is pure or almost pure oxygen, however, it is advantageous if the lift gas is formed by a “second oxygen-enriched gas”, which has an oxygen content that is at least equal to the oxygen content of the oxygen-enriched working fluid.

The “second oxygen-rich gas” can be formed, for example, by compressing the first oxygen-rich gas that is produced in the evaporator. If the unit already produces a pressurized gaseous product, the second oxygen-rich gas can be diverted from the pressurized gaseous product. In the case of an external compression (i.e., the gaseous compression of the oxygen product), the lift gas can be diverted at the outlet of the product compressor or its secondary condenser. The lift gas can be fed to the conveying device warm. Alternatively, the lift gas can be cooled off upstream from the conveying device, for example, in countercurrent to the cold process streams (e.g., in a main heat exchanger). In the internal compression, the oxygen product is first brought to a high pressure in liquid form and then is (pseudo-)evaporated to a pressurized gas. A portion of this pressurized gas can be used cold or warm as lift gas within the scope of the invention.

The circulation liquid is returned to the evaporation passages via a riser. Within the scope of the invention, it is advantageous if the conveying device for injecting the lift gas is arranged in the lower section of the riser (i.e., in the lower half, preferably in the lower third of the riser) relative to the lowest and the highest geodetic point of the riser. In an embodiment, injection of the lift gas takes place as far down the riser as possible.

The circulation liquid can be directed at least in part together with the working fluid to the evaporation passages. For example, the entire circulation liquid is first mixed with the working fluid, and the mixture is then sent via the conveying device into the evaporation passages.

In addition or as an alternative, the circulation liquid is conveyed by the conveying device at least in part separated from the working fluid. For example, only the circulation liquid is directed through an air-lift pump, while the working fluid is transported by an existing hydrostatic gradient or by a pump into the evaporation passages.

The evaporator of the present invention is preferably at least partially designed as a falling-film evaporator. The evaporator may be configured, for example, as a combination that comprises two or more sections, of which at least one is designed as a falling-film section and at least one other is designed as a circulation section, in which liquid is forced to circulate by the thermosiphon effect. As an alternative, the evaporator may be designed as a pure falling-film evaporator. In this case, the evaporator may comprise one or more heat exchanger blocks, which preferably are configured as aluminum plate heat exchangers. The process according to the present invention is advantageous in the case of multi-level thermosiphon evaporators, so-called cascade evaporators, as they are known, for example, from DE 1949609 B, WO 0192798 A2 (US 20050028554 A1), EP 1287302 B1 (U.S. Pat. No. 6,748,763 B2) or WO 03012352 A2.

In addition, the present invention relates to a device for evaporating an oxygen-enriched working fluid.

In addition, the present invention relates to a process and device for low-temperature air separation.

The invention as well as additional details of the invention are explained in more detail below based on the embodiments that are roughly diagrammatically shown in the drawings.

### BRIEF DESCRIPTION OF THE DRAWINGS

FIG. 1 shows a first embodiment of the present invention with an evaporator arranged between two separation columns.

FIG. 2 shows a second embodiment of the present invention with an evaporator on the top of one of two separation columns that are arranged beside one another.

FIG. 3 is a schematic diagram of an evaporator.

### DETAILED DESCRIPTION OF THE DRAWINGS

Both embodiments according to the present invention are directed to the evaporation process of a main condenser of an air separation unit in which the distillation column system is formed as a two-column system for nitrogen-oxygen separation. The distillation column system may have additional separation columns that are not shown in the drawings, for example, for recovering noble gases (such as at least one of argon, krypton, or xenon). The principles of low-temperature separation of air in general as well as the design of two-column units in particular are described in the monograph “Tieftemperaturtechnik [Low-Temperature Technology]” by Hausen/Linde (2^{nd} Edition, 1985) and in an essay by Latimer in Chemical Engineering Progress (Vol. 63, No. 2, 1967, page 35), the disclosures of which are incorporated by reference.

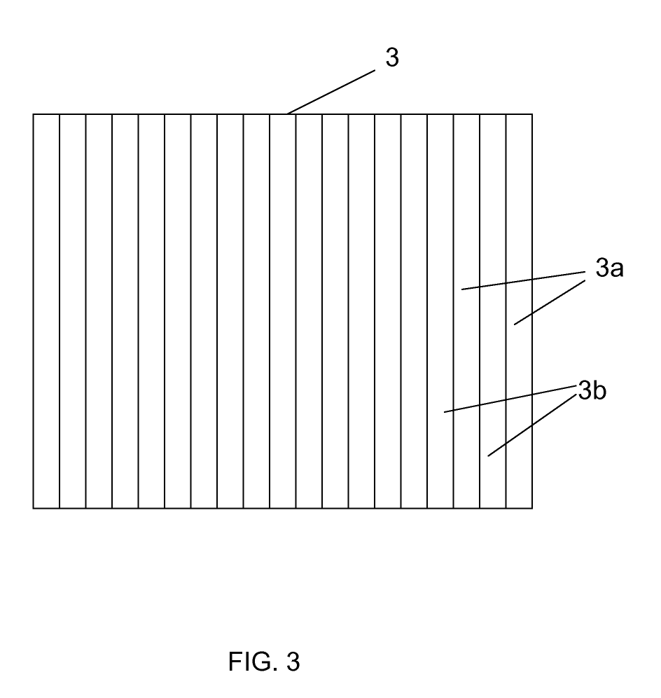

A two-column system comprises a high-pressure column (“second separation column”) in which at least a portion of the charging air is introduced, and a low-pressure column (“first separation column”), in which oxygen is recovered. These two separation columns are in a heat-exchange relationship via a main condenser. The main condenser is designed as a condenser-evaporator. On the one hand, the main condenser acts as an “evaporator” for an “oxygen-rich working fluid,” which is formed by oxygen from the low-pressure column, and is introduced into evaporation passages 3a. On the other hand, the main condenser acts as a condenser for gaseous nitrogen from the high-pressure column, which is introduced into the liquefaction passages 3b (FIG. 3).

In the example of FIG. 1, the distillation-column system has a double column, i.e., the low-pressure column 2 is arranged above the high-pressure column 1. Between the two columns (more specifically, at the bottom of the low-pressure column), a main condenser 3, which may be designed as a falling-film condenser or cascade condenser, is arranged. In an embodiment of the present invention, the main condenser 3 comprises a falling-film evaporator.

An “oxygen-rich working fluid” is formed by the reflux liquid of the low-pressure column, which collects on the lowermost plate or in a collecting device that is arranged thereunder and is released above in the evaporation passages of the main condenser 3. There, the oxygen is partially evaporated. The gaseous oxygen that is produced (the “first oxygen-enriched gas”) flows together with the portion that remains liquid in the outside chamber of the main condenser 3, which is formed in FIG. 1 by the bottom chamber of the low-pressure column. The gas rises in the low-pressure column and enters there into material and heat exchange with incoming downward flowing liquid. The portion that remains liquid is returned as circulation liquid to the evaporation passages via the line 4 and line 5.

According to the present invention, the liquid circulation is driven by an air-lift pump 6, in which a lift gas 7 is injected into the liquid stream after a compression via valve 8 to a suitable pressure in line 9. By the injected gas, the density of the liquid stream in the riser line 5 is reduced, and the hydrostatic pressure of the liquid being applied in the liquid line 4 via a height h1 above the air-lift pump is sufficient to raise the liquid that is diluted with gas bubbles in the riser line 5 via the greater height h2. The valve 8 determines the mass flow of the lift gas and thus also the mass flow of liquid.

The height differences between the lower end of the evaporation passages and the lower level are greater by at least a factor of 2, for example by at least a factor of 5, than the height differences between the upper level and the upper end of the evaporation passages. In embodiments, the height differences between the lower end of the evaporation passages and the lower level are greater by at least a factor of 10 than the height differences between the upper level and the upper end of the evaporation passages.

The lift gas 7 may be formed by pressurized gaseous oxygen, which is diverted from the oxygen product of the air separation unit. The oxygen product can be removed, for example, in gaseous form from the low-pressure column 2, heated in a main heat exchanger against charging air, and compressed in the gaseous state (not shown). As an alternative, liquid oxygen may be brought to high pressure from the low-pressure column in liquid state, evaporated in indirect heat exchange with coolant, such as, for example, highly compressed charging air (or pseudo-evaporated, if the pressure is supercritical), and heated.

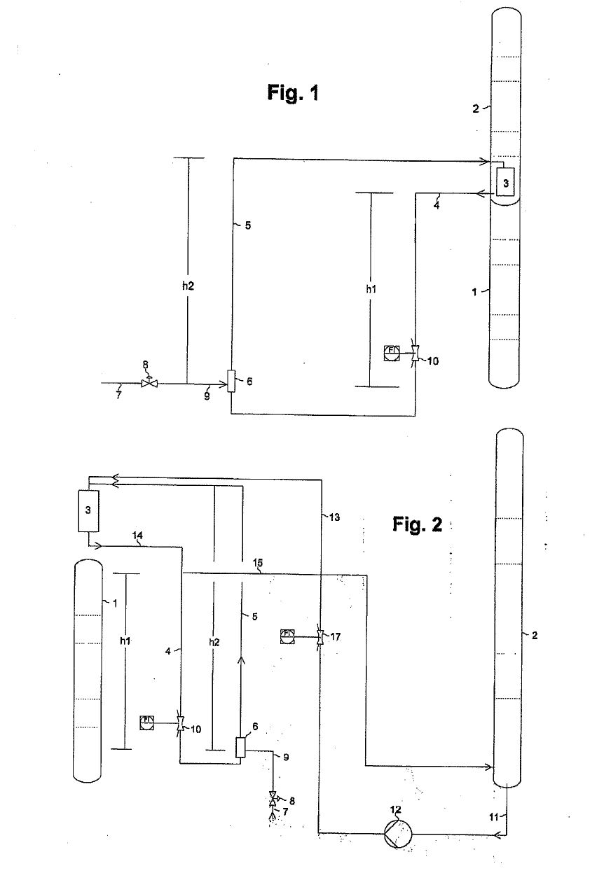

The embodiment of FIG. 2 shows a similar system, but the high-pressure column 1 and the low-pressure column 2 are arranged beside one another. The main condenser 3 comprises a falling-film evaporator and is arranged above the high-pressure column 1. Here, the “oxygen-rich working fluid” is conveyed separately via the lines 11 and 13 as well as by the mechanical pump 12 to the evaporation passages of the main condenser 3. The two-phase mixture 14 that emerges from the evaporation passages is separated into a gas portion, the “first oxygen-enriched gas” 15, and a liquid portion, the circulation liquid in the liquid line 4. Other connections may be according to a standard air separation double column, for example, as disclosed in “Tieftemperaturtechnik [Low-Temperature Technology]” by Hausen/Linde, 2^{nd} Ed., 281-337 (1985).

Analogously to FIG. 1, but separately from the liquid 11, 13 from the low-pressure column 2, the circulation liquid is recycled by an air-lift pump 6 to the evaporation passages of the main condenser 3. For this purpose, the circulation liquid is first directed downward into liquid line 4, so that one liquid column of height h1 can force the gas bubble-filled liquid into the riser line 5 via height h2 into the evaporation passages. In a specific embodiment, 135,000 Nm³/h flows via the pump 12, and 270,000 Nm³/h is conveyed into the circulation circuit by the air-lift pump 6, which injects 350 Nm³/h of lift gas 7 via line 9. These mass flows are adjusted via the valves 10 and 17.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A process for evaporating an oxygen-enriched working fluid by indirect heat exchange in an evaporator, comprising:
introducing an oxygen-rich working fluid into evaporation passages of an evaporator;
partially evaporating the oxygen-rich working fluid;
drawing off a first oxygen-enriched gas and a portion of the oxygen-enriched working fluid that remains liquid from the evaporation passages;
returning at least a part of the portion of the oxygen-enriched working fluid that remains liquid to the evaporation passages as a circulation liquid in a liquid cycle having an upper level and a lower level; and
injecting a lift gas into the liquid cycle via a conveying device,
wherein the height differences between the lower end of the evaporation passages and the lower level are greater than the height differences between the upper level and the upper end of the evaporation passages.

2. A process according to claim 1, wherein the lift gas is formed by a second oxygen-enriched gas having an oxygen content that is at least equal to the oxygen content of the oxygen-enriched working fluid.

3. A process according to claim 1, wherein the circulation liquid is returned via a riser line to the evaporation passages, and wherein the conveying device is arranged in the lower half of the riser line.

4. A process according to claim 3, wherein the conveying device is arranged in the lower third of the riser line.

5. A process according to claim 1, wherein the circulation liquid is directed at least partially together with the working fluid into the evaporation passages.

6. A process according to claim 1, wherein the circulation liquid is conveyed by the conveying device at least in part separated from the working fluid.

7. A process according to claim 1, wherein the evaporator is designed at least partially as a falling-film evaporator.

8. A process according to claim 1, wherein the height differences between the lower end of the evaporation passages and the lower level are greater by at least a factor of 2 than the height differences between the upper level and the upper end of the evaporation passages.

9. A process according to claim 1, wherein the height differences between the lower end of the evaporation passages and the lower level are greater by at least a factor of 5 than the height differences between the upper level and the upper end of the evaporation passages.

10. A process according to claim 1, wherein the height differences between the lower end of the evaporation passages and the lower level are greater by at least a factor of 10 than the height differences between the upper level and the upper end of the evaporation passages.

11. A device for evaporating an oxygen-enriched working fluid by indirect heat exchange, comprising:
an evaporator having evaporation passages for partial evaporation of an oxygen-rich working fluid;
means for introducing the oxygen-rich working fluid into the evaporation passages;
means for drawing off a first oxygen-enriched gas;
means for returning at least a part of the portion of the oxygen-rich working fluid that remains liquid as a circulation liquid in a liquid cycle to the evaporation passages, wherein the liquid cycle has an upper level and a lower level,
means for drawing off a portion of the oxygen-enriched working fluid that remains liquid from the evaporation passages; and
a conveying device for the circulation liquid having means for injecting a lift gas,
wherein the height differences between the lower end of the evaporation passages and the lower level are greater than the height differences between the upper level and the upper end of the evaporation passages.

12. A process for low-temperature separation of air in a distillation-column system, comprising:
introducing compressed and purified charging air into a distillation-column system;
recovering an oxygen-enriched working fluid in a first separation column; and
subjecting the oxygen-enriched working fluid to a process for evaporation according to claim 1.

13. A process according to claim 12, further comprising introducing a produced first oxygen-enriched gas at least in part into the first separation column.

14. A process according to claim 12, wherein the distillation-column system comprises a second separation column and an evaporator comprising a condenser-evaporator, wherein a gaseous fraction from the second separation column is introduced into liquefaction passages of the condenser-evaporator.

15. A process according to claim 14, wherein at least a portion of the liquid that is formed in the liquefaction passages is introduced into the second separation column.

16. A device for low-temperature separation of air with a distillation-column system, comprising:
at least a first separation column;
means for introducing compressed and purified charging air into the distillation-column system;
means for recovering a liquid fraction in the first separation column;
a device according to claim 11 for evaporating this liquid fraction as an oxygen-enriched working fluid.

17. A process according to claim 1, wherein the conveying device comprises a gas-lift pump.

18. A device according to claim 11, wherein the conveying device comprises a gas-lift pump.

19. A device for evaporating an oxygen-enriched working fluid by indirect heat exchange, comprising:
an evaporator having evaporation passages for partial evaporation of an oxygen-rich working fluid;
a line for drawing off a first oxygen-enriched gas;
a line for drawing off a portion of the oxygen-enriched working fluid that remains liquid;
a line for returning at least a part of the portion of the oxygen-enriched working fluid that remains liquid as a circulation liquid in a liquid cycle to the evaporation passages, wherein the liquid cycle has an upper level and a lower level; and
an gas-lift pump for injecting a lift gas into the circulation liquid,
wherein the height differences between the lower end of the evaporation passages and the lower level are greater than the height differences between the upper level and the upper end of the evaporation passages.
